(19) United States
(12) Patent Application Publication
(10) Pub. No.: US 2026/0156474 A1
(43) Pub. Date: Jun. 4, 2026

(54) METHOD AND DEVICE FOR TRANSFERRING A PROFILE BETWEEN TWO SECURE ELEMENTS

(71) Applicant: IDEMIA FRANCE, Courbevoie (FR)

(72) Inventors: Jérôme DUMOULIN, Courbevoie (FR); Elder DOS SANTOS, Courbevoie (FR)

(73) Assignee: IDEMIA FRANCE, Courbevoie (FR)

(21) Appl. No.: 19/398,197

(22) Filed: Nov. 24, 2025

(30) Foreign Application Priority Data
Nov. 29, 2024 (FR) FR2413257

(51) Int. Cl. H04W 12/43

(52) U.S. Cl. CPC H04W 12/43

(57) ABSTRACT

The invention relates to a method for transferring a current profile from a source secure element on a source device to a target secure element on a target device, the method comprising the steps of:
the source secure element monitoring and recording the changes made to an initial profile installed in the source secure element to obtain the current profile;
the source secure element generating a difference file relating to differences between the initial profile and the current profile on the basis of the recorded changes;
an SM-DP+ obtaining the initial profile and generating a profile to be installed on the target secure element;
loading and installing the generated profile in the target secure element, the installed profile matching the initial profile to which the generated difference file has been applied.

### TECHNICAL FIELD

The invention relates to the management of connection profiles in a secure element of a device that can be connected to a cellular network.

### BACKGROUND ART

A device that can be connected to a cellular communications network, such as a mobile phone, traditionally comprises a secure element that is used to authenticate it on the communication, typically mobile phone, network or networks. Secure elements of this kind include universal integrated circuit cards (UICC), in particular SIM (Subscriber Identity Module) cards, and their integrated version known by the name eUICC (embedded UICC), also called an eSIM. An eUICC module is a, typically small, secure hardware element that can be integrated in a host mobile terminal in order to use the functions of a traditional SIM card.

eUICCs can comprise multiple subscriptions or profiles, each of which corresponds to an operator. Each profile comprises subscription data, for example an IMSI (International Mobile Subscriber Identity) identifier, cryptographic keys and algorithms, which are specific to a subscription delivered by a mobile phone operator.

eUICC cards provide greater flexibility in the management of subscriptions, and in particular in the delivery and remote management of profiles. This is because eUICC cards are reprogrammable and therefore allow multiple subscriber profiles (or communication profiles) to be loaded, deleted and updated on the same eUICC card over time. Each subscriber profile is held in a secure container (denoted ISD-P (Issuer Security Domain Profile), which can hold only one profile) that, like a conventional SIM card, holds the data that, when the profile is active, allow it to authenticate itself with a corresponding mobile phone network to access a (for example voice or data) service.

By changing the active subscriber profile in the eUICC card, it is possible to change operator or alter access to associated services.

The specification SGP.22—RSP Technical Specification—version 2.3 —Jun. 30,2021, SGP.22 below, describes in particular a technical solution for delivering and remotely managing eUICCs in mainstream terminals (consumer devices). The procedures described are typically performed by the terminal (including the eUICC) to manage eUICCs (in the sense of administering the states of profiles, for example activated, deactivated, deleted, and so on) and initiate delivery of a profile (for example a request to load (or deliver) a profile on an eUICC) and performed by a server, known as SM-DP+ (Subscription Manager Data Preparation enhanced), as part of a technical solution for delivering (or providing, or even distributing) profiles in eUICCs.

The specification SGP.02—Remote Provisioning Architecture for Embedded UICC Technical Specification—version 4.2 —Jul. 7, 2022, SGP.02 below, describes a technical solution for delivering and remotely managing eUICCs integrated in M2M (Machine to Machine) terminals. The procedures described are typically performed by a pair of servers, known as SM-DP (Subscription Manager Data Preparation) and SM-SR (Subscription Manager Data Secure Routing).

Typical procedures for managing eUICCs as described in these specifications include, among other things, loading and installing a profile, activating a profile, deactivating a profile, and deleting a profile.

When the user of a device that can be connected to a cellular communications network subscribes with an operator, a connection profile is generated, transferred and installed on the secure element of the device. This profile typically contains a file system and applications linked to the user's subscription.

However, such a profile is not immutable. Some operations bring about changes to the profile. These operations may be performed by the user, for example changing their personal identification code (Personal Identification Number, PIN, code), or subscribing to a service attached to their subscription. Other operations may be performed by the operator, for example updating certain components of the profile. All of these operations bring about changes to the profile over the course of time.

In some circumstances, the user may wish to transfer their subscription, and therefore their profile, from one device to another. The typical use case is a person who gets a new mobile phone and wishes to transfer their subscription from their old phone to the new one.

When devices use physical SIM cards, this operation is simple. The user removes their SIM card from their old phone and inserts it into the new one, which can then use the user's subscription to connect to the cellular communications network. As the user's profile is stored in the SIM card, this profile is transferred with this card in its current state. The user therefore retrieves all of the customizations and updates that have been made to their initial profile over time.

In the case of embedded secure elements, such as eUICCs, for example, the transfer is distinctly more complex. It is no longer possible to transfer the secure element as a whole, including the current profile, from one device to another. Only the profile needs to be transferred from one secure element to another. This transfer encounters the security mechanisms introduced in the standard. In particular, a profile is linked to one secure element and it is not usually possible to use it on another secure element. Moreover, loading and installing a profile requires compliance with the constraints on format, compression and other aspects to comply with the installation mechanisms introduced by the aforementioned standards.

The presented invention aims to solve these problems.

### SUMMARY OF THE INVENTION

To this end, the invention proposes a method for transferring a profile from a source eUICC to a destination eUICC. According to this method, the source eUICC that loaded and installed an initial profile keeps a file, called a delta, that lists all changes made to the initial profile over time. A file should be understood to mean any type of data format that ensures traceability and recording of information relating to a datum, for example and in a non-limiting way, a profile element, a specific value, a stored variable or an object of a computer language stored in an electronic memory, a memory register, a database, and so on. When the profile transfer is initiated by the source eUICC, this source eUICC obtains the identifier of the destination eUICC and notifies the SM-DP+ of the future transfer. The SM-DP+ retrieves the initial profile that was loaded on the source eUICC. In a first embodiment, the source eUICC transmits a delta to the SM-DP+, which applies it to the initial profile to prepare a profile that matches the current profile of the source eUICC, and which can then be loaded and installed on the destination eUICC. Delta should be understood to mean all differences that, starting from the initial profile, lead to the current profile or produce, for example, a difference in content or memory occupancy size. These differences may be, for example and in a non-limiting and potentially cumulative way, an application installation, the changing of any value, the deletion of a file, the identification, referencing or even registration or localization of a change, and so on. In a second embodiment, the source eUICC also transmits the delta to the SM-DP+, but the SM-DP+ does not apply it to the initial profile. It is this initial profile that is loaded and installed in the destination eUICC. The SM-DP+ transmits the delta to the destination eUICC, which applies it to the installed initial profile. In a third embodiment, the source eUICC transmits the delta not to the SM-DP+ but directly to the destination eUICC, which can then apply it after loading and installing the initial profile obtained from the SM-DP+. Applying a delta to an initial profile makes it possible, for example, to integrate, install and take into account any differences that have arisen on the initial profile to arrive at a profile whose technical characteristics are identical to those of a current reference profile and towards which it is desired to converge.

In all of the embodiments, the SM-DP+ controls the transfer. It updates the link information between the profile and the eUICC on which the profile is installed. It also ensures that the profile is deactivated in the source eUICC before any activation of the profile in the destination eUICC, to ensure that the same profile cannot be active in two different eUICCs.

The proposal is thus a method for transferring a current profile from a source secure element on a source device to a target secure element on a target device, the method comprising the following steps:
the source secure element monitoring and recording the changes made to an initial profile installed in the source secure element to obtain the current profile;
the source secure element generating a difference file relating to differences between the initial profile and the current profile on the basis of the recorded changes;
an SM-DP+ obtaining the initial profile and generating a profile to be installed on the target secure element; and
loading and installing the generated profile in the target secure element, the installed profile matching the initial profile to which the generated difference file has been applied.

In one embodiment, the method also comprises the following steps:
the source secure element transmitting the difference file to the SM-DP+; and
the SM-DP+ applying the difference file to the initial profile to generate the profile to be installed.

In one embodiment, the method also comprises the following steps:
the source secure element transmitting the difference file to the target secure element; and
if the generated profile matches the initial profile, the target secure element applying the difference file to the initial profile after it has been installed.

In one embodiment, the difference file is transmitted by the source secure element to the target secure element via the SM-DP+.

In one embodiment, the difference file is transmitted by the source secure element to the target secure element by way of a direct connection between the source device and the target device.

In one embodiment, if the current profile comprises Javacard applications, the difference file incorporates, for each Javacard application, a data packet that represents the state of the Javacard application.

The proposal is also a method for transferring a current profile from a source secure element on a source device to a target secure element on a target device, the method comprising the following steps by the source secure element:
the source secure element monitoring and recording the changes made to an initial profile installed in the source secure element to obtain the current profile;
the source secure element generating a difference file relating to differences between the initial profile and the current profile on the basis of the recorded changes; and
transmitting the difference file to the target device or to an SM-DP+ server.

The proposal is also a method for transferring a current profile from a source secure element on a source device to a target secure element on a target device, the method comprising the following steps by the target secure element:
loading and installing an initial profile;
receiving a difference file relating to differences between the initial profile and the current profile; and
applying the difference file to the installed initial profile to obtain the current profile.

The proposal is also a source secure element comprising a processor, the processor being configured to perform the following steps to transfer a current profile from a source secure element on the source device to a target secure element on a target device:
monitoring and recording the changes made to an initial profile installed in the source secure element to obtain the current profile;
the source secure element generating a difference file relating to differences between the initial profile and the current profile on the basis of the recorded changes; and
the difference file to the target device or to an SM-DP+ server.

The proposal is also a target secure element comprising a processor, the processor being configured to perform the following steps to transfer a current profile from a source secure element on a source device to the target secure element on a target device:
loading and installing an initial profile;
receiving a difference file relating to differences between the initial profile and the current profile; and
applying the difference file to the installed initial profile to obtain the current profile.

The present invention also covers a computer program comprising instructions for carrying out the method described above when this program is executed by a processor.

This program may use any programming language (for example an object language or the like) and take the form of an interpretable source code, a partially compiled code or a fully compiled code.

Another aspect relates to a non-transient storage medium for a computer-executable program, comprising a dataset representing one or more programs, said one or more programs comprising instructions for, during execution of said one or more programs by a computer comprising a processing unit operatively coupled to memory means and to an input/output interface module, executing all or some of the method described above.

### BRIEF DESCRIPTION OF THE DRAWINGS

Other features, details and advantages of the invention will become apparent upon reading the detailed description below. Said description is purely illustrative and should be read with reference to the appended drawings, in which:

FIG. 1 illustrates the general architecture of a system for implementing the invention;

FIG. 2 illustrates the main steps of a method for transferring a profile between a source eUICC and a target eUICC according to two first embodiments of the invention;

FIG. 3 illustrates the main steps of a method for transferring a profile between a source eUICC and a target eUICC according to a third embodiment of the invention;

FIG. 4 is a schematic block diagram of an information processing device for implementing one or more embodiments of the invention.

### DETAILED DESCRIPTION

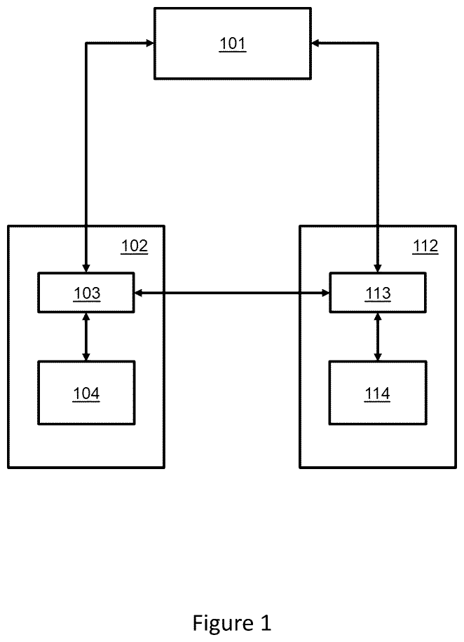

FIG. 1 illustrates the general architecture of a system for implementing the invention.

A first device 102 that can be connected to a cellular communications network, called a source device, comprises a secure element 104, for example an eUICC. The eUICC 104, also called the source secure element 104 or even the source eUICC 104, comprises an operating system and at least one connection profile that allows the source device to connect to the cellular communications network. The source device 102 also comprises a module 103 for local management of profiles (Local Profile Assistant, LPA). The LPA 103 manages the profiles of the eUICC 104. The LPA handles communications between an SM-DP+ server 101 and the eUICC 104 to allow profile loading and switching between networks. Optionally, the LPA 103 can be located in the eUICC 104 instead of in the source device 102.

A second device 112, similar to the first device 102, comprises its LPA 113 and its secure element 114, for example an eUICC. The second device 112 is the target device in the profile transfer method described in this document and the secure element 114 is the target secure element, also called the target eUICC 114. Optionally, the LPA 113 can be located in the target secure element 114 instead of in the target device 112.

The SM-DP+ server is responsible for preparing (or generating), distributing (or delivering, or even providing) and managing the connection profiles used by the devices that can be connected to a cellular communications network. The SM-DP+ receives a profile preparation (or generation) request from the operator of the cellular communications network and prepares (or generates) at least one profile for installation on a particular eUICC. The profiles are prepared by the SM-DP+ 101 on the basis of data files or data delivered by the operator of the cellular communications network, as part of the preparation request sent by the operator. This preparation essentially consists in, for example and in a non-limiting way, describing all the files and applications of the profile, positioning all the unique identifiers of the profile (for example the IMSI (International Mobile Subscriber Identity)), defining and setting up the means so that the profile can be loaded on only one recipient eUICC, and so on. Also, for example, the SM-DP+ prepares the profile packets, secures them with a profile protection key, and stores the profile protection keys securely and the protected profile packets in a secure repository. The SM-DP+ also allocates the secure profile packets to the specified eUICC identifiers (or to one eUICC identifier, called the eID (eUICC IDentifier)). The SM-DP+ also links the protected profile packets to the corresponding eUICC identifier (or eID) and securely downloads these linked profile packets to the LPA of the corresponding eUICC. In addition, the SM-DP+ is also responsible for managing the state of profiles (for example activated, deactivated, deleted, and so on) on the eUICC. The profile is then encrypted using keys negotiated with the eUICC that receives the profile. The profile can then be transmitted to the LPA, which will load it into the eUICC of the device to install it.

The SM-DP+ also keeps a register of installed profiles containing the link between the profile and the eUICC on which the profile is installed. The SM-DP+also ensures that only authorized entities can access it.

Communications between a device that can be connected to a cellular communications network and the SM-DP+ can use the cellular communications network when an active connection profile is present in the secure element of the device. Alternatively, an alternative network interface of the device can be used. For example, the device can comprise a WiFi interface for accessing the Internet.

Direct communication between the LPAs of the source and target devices can also use the cellular communications network when an active connection profile is present in the secure element of both devices. Alternatively, when both devices are connected to the same WiFi network, the WiFi network can be used for these communications. Alternatively, a point-to-point network, typically using Bluetooth technology, can be set up between the two devices. Finally, it is also possible to use near field communication (NFC) technologies to exchange information between the two devices.

Profile export from an eUICC can be applied in different use cases. A first use case is when an operation, for example updating the operating system of the eUICC, requires a lot of memory. In this case, it may be desirable to export a profile, perform the operation and then re-import the profile. A second use case is the case, presented in the introduction to this document, of transferring a profile from one device to another, for example when a user changes their device.

In the first use case, the profile is imported back into the same eUICC. As a result, it does not exhibit any interoperability constraint. In the second use case, the target eUICC can be produced by a manufacturer other than the one that produced the source eUICC, so the exported profile must be interoperable with the various eUICCs on the market.

A standard interoperable profile format exists: the SAIP (SIMAlliance Interoperable Profile) format, defined in particular by the Trusted Connectivity Alliance (TCA) standard and entitled eUICC Profile Package: Interoperable Format Test Specification, for example in its version 3.2.1 published in December 2022, used by the SM-DP+ when preparing profiles for loading onto an eUICC. However, adopting this format to export a profile from an eUICC requires the functionalities linked to this format that are used by the SM-DP+ to be ported to the eUICC. This solution encounters the difficulty of implementing these functionalities in the eUICC due to the low memory and computation resources of eUICCs.

A profile referred to as “current” that is present in the source eUICC is the profile that needs to be exported. This current profile matches an initial profile loaded and installed in the source eUICC, which initial profile was changed upon or during use of the source device. According to one aspect of the invention, a file relating to the differences between the initial profile and the current profile is generated by the source eUICC. Thus, it is possible to use the initial profile and this difference file to retrieve the current profile.

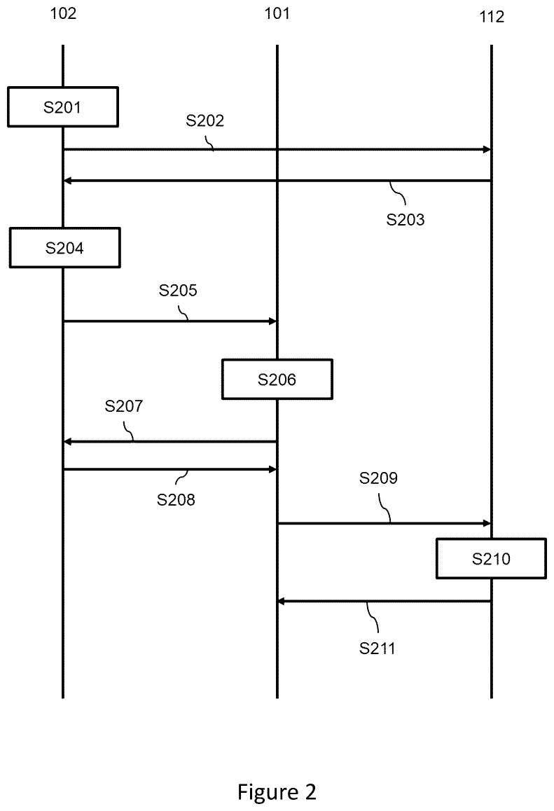

FIG. 2 illustrates the main steps of a method for transferring a profile between a source eUICC and a target eUICC according to two first embodiments of the invention.

In step S201, the source eUICC monitors and records all changes made to the file system during the life of the profile. This monitoring must begin as soon as the initial profile is installed and must continue for as long as the profile is in use by, and/or present on, the source device. Changes that can be made to the file system include deleting a file, adding a new file, or modifying an existing file. All of these changes are recorded by the source eUICC. Similarly, deletion and addition of applications from/to the profile are also monitored, as are changes to application data. Data linked to a user of an application or to the use of an application are also monitored and recorded by the source eUICC as part of changes made to the profile in which the application is installed or is part. In one embodiment, only data linked to an application in a profile are monitored and recorded as part of the monitoring and recording of all differences introduced into the file system.

In step S202, when the transfer is requested, typically by the user of the device, the source device requests the identifier of the target eUICC. This request is typically made by the LPA of the source device to the LPA of the target device. This request is typically transmitted via a WiFi network to which both devices are connected, or via a Bluetooth connection between the two devices, or via an NFC connection between the two devices.

In step S203, the target device transmits the identifier of the target eUICC to the source device. The transmission is typically carried out by the LPA of the target device to the LPA of the source device.

In step S204, the source eUICC generates a file relating to the differences between the initial profile installed in the source eUICC and the current profile on the basis of all the differences continuously recorded in step S201. This difference file is called the Delta in this document. Advantageously, the source eUICC generates a token to verify the origin of the difference file and its integrity. For example, the token can be a checksum of the Delta, typically a hash value computed for the content of the Delta and signed by the source eUICC.

According to a first alternative, the complete content of the modified or added files is added to the Delta. According to another alternative, for modified files, the modified byte ranges are indicated and only these byte ranges are transmitted in the Delta.

There may be instances where the profile comprises Javacard applications. These applications are distinguished by the existence of instances of the application that persist in memory. Monitoring changes to the file system is then not sufficient to reflect changes in the initial profile.

The standard provides for a mechanism known as Amendment H specified in the document GlobalPlatform Technology Executable Load File Upgrade Card Specification v2.3—Amendment H Version 1.1 under the reference GPC_SPE_120. This mechanism is intended to facilitate the updating of Javacard applications. It allows a Javacard application to export its state as a data packet. It is thus possible for a Javacard application to export its state before being deleted. A new version of the Javacard application is then installed. This new version then re-imports the state from the previously exported data packet. The use of Amendment H requires the Javacard application to be compatible, that is to say that it implements the routines that allow export, and then import, of its state as a data packet in accordance with Amendment H.

When the profile to be transferred comprises one or more Javacard applications, these applications must be compatible with Amendment H. The mechanism of Amendment H is diverted from its initial purpose to generate for each Javacard application of the profile a data packet representing its state which is integrated in the Delta difference file. It is then possible, during installation of the profile, for Javacard applications to import these data packets and retrieve the state they had in the current profile in the source eUICC.

In step S205, the source device notifies the SM-DP+ of the initiated transfer between the source device and the target device. This notification includes the Delta file transmitted to the SM-DP+. When a token is computed, it is also transmitted to the SM-DP+, which can then verify the origin and integrity of the Delta. The notification also includes the identifier of the target eUICC.

In step S206, the SM-DP+ uses the identifier of the source eUICC from which the notification originated to retrieve the initial profile that was transmitted and installed in the source eUICC.

In a first embodiment, the SM-DP+ that has the initial profile and the Delta difference file relating to differences between this initial profile and the current profile applies these differences to the initial profile and prepares a profile that matches the current profile for the target eUICC. It should be noted that data packets corresponding to the state of a Javacard application cannot be applied by the SM-DP+. This is because these data packets can be imported only by the Javacard application itself after it has been installed on the target eUICC. These packets, when present in the Delta, are then integrated by the SM-DP+ into the profile it generates so that they can be used during installation on the target eUICC.

Alternatively, data packets corresponding to the state of a Javacard application are made available to the target eUICC on a server. A URL (Uniform Resource Locator) address is then delivered to the target eUICC to allow these data packets to be loaded using the mechanism known as Amendment B described in the document GlobalPlatform Technology Remote Application Management over HTTP Card Specification v2.3—Amendment B Version 1.2 under the reference GPC_SPE_011.

In a second embodiment, the SM-DP+ prepares a profile that matches the initial profile for the target eUICC. This initial profile is constrained by the SM-DP+ to prevent it from being able to be used directly by the target eUICC without first applying the Delta. In this embodiment, the SM-DP+ prepares a profile that matches the initial profile but does not apply the delta thereto. The target eUICC will be responsible for applying the delta to the prepared profile that is received. The delta will be sent, together with the profile that matches the initial profile, by the SM-DP+ to the target eUICC. In this embodiment, applying the delta to the initial profile is the final step in installing the received profile. The installed profile is therefore the initial profile to which the delta has been applied.

In step S207, the SM-DP+ notifies the source eUICC that the notification and the Delta have been duly received.

On receiving the notification from the SM-DP+, the source eUICC deletes the current profile and notifies the SM-DP+ of this deletion in step S208. This is because the same profile cannot be installed, or at least activated, in two different eUICCs. The SM-DP+ is responsible for complying with this constraint. As such, the SM-DP+ allows the transferred profile to be loaded and installed in the target eUICC only once it has been assured that it has been deleted, or at least deactivated, in the source eUICC. The SM-DP+ thus ensures that the transferred profile is linked to only one eUICC at a time.

In step S209, the profile prepared by the SM-DP+ is transmitted to the LPA of the target device for installation in the target eUICC. In the first embodiment, if the transmitted profile matches the current profile, it can be directly loaded and installed in the target eUICC. In the second embodiment, the transmitted profile is the initial profile. The Delta file is then transmitted with the profile, as well as the token if it has been generated.

In step S210, the transmitted profile is loaded and installed in the target eUICC. In the second embodiment, the target eUICC installs the initial profile and then applies the Delta file to obtain an installed profile that matches the current profile that was installed in the source eUICC. In both embodiments, at the end of step S210, the current profile that was to be transferred is installed in the target eUICC.

In step S211, the target eUICC provides notification that the profile has been successfully installed in the target eUICC. The SM-DP+ can then update the link information between the profile and the eUICC on which it is installed. The initial profile is then linked to the target eUICC instead of to the source eUICC.

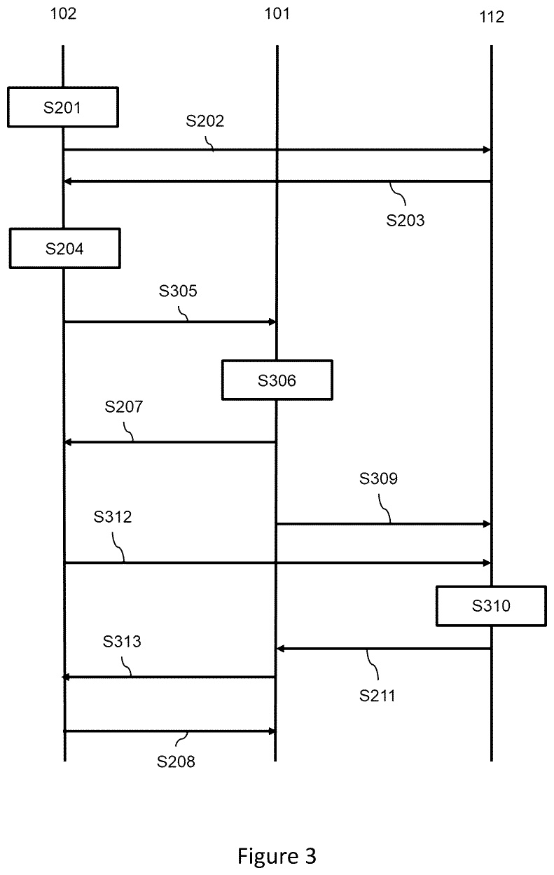

FIG. 3 illustrates the main steps of a method for transferring a profile between a source eUICC and a target eUICC according to a third embodiment of the invention.

This third embodiment of the invention differs from the first two essentially in the method of transmitting the Delta difference file between the source eUICC and the target eUICC. In this third embodiment, the Delta is transmitted directly by the source device to the target device. This transmission uses a direct connection between the LPAs of the source and target devices.

The steps that are identical to the steps in FIG. 2 reuse the references of FIG. 2 and will not be described again.

Step S305 corresponds to step S205 except that the Delta is not transmitted by the source device to the SM-DP+.

In step S306, the profile prepared by the SM-DP+ matches the initial profile that has been loaded and installed in the source eUICC.

In step S309, the initial profile is transmitted by the SM-DP+ to the target device. This transmission does not include the Delta, as the Delta has not been transmitted to the SM-DP+.

The Delta file is transmitted directly from the source device to the target device in step S312. This transmission uses the direct connection between the LPA of the source device and the LPA of the target device. When the token is generated, it can be transmitted together with the Delta to allow the target device to verify the origin and integrity of that Delta. Alternatively, the token can be transmitted to the SM-DP+ in step S305 and retransmitted to the target device together with the initial profile in step S309.

Step S310 corresponds to step S210 according to the second embodiment. That is to say that the LPA of the target device has the initial profile (received as part of step S309), which it transmits to the target eUICC for installation. The Delta is then also transmitted, by the LPA (received as part of step S312), to the target eUICC, which applies it to the initial profile to obtain the current profile.

This third embodiment also differs from the first and second embodiments in terms of when the current profile can be deleted from the source eUICC. In the third embodiment, the eUICC is notified in step S313 that the current profile has been successfully installed in the target eUICC. Only then does the source eUICC delete the current profile and notify the SM-DP+ of this in step S208. It should be noted that the SM-DP+ allows the current profile to be activated in the target eUICC only once it has received notification that it has been deleted from the source eUICC. In one embodiment, the notification sent by the SM-DP+ in step S313 also corresponds to a sequence of commands to deactivate and delete the current profile on the source eUICC.

Thus, the method described allows the SM-DP+ to control transfer of the profile and to keep the link information between the profile and the eUICC in which it is installed up to date. The method described reduces the need for direct communication between the source and target devices. It also reduces the need to prepare the profile on account of the initial profile already generated being reused.

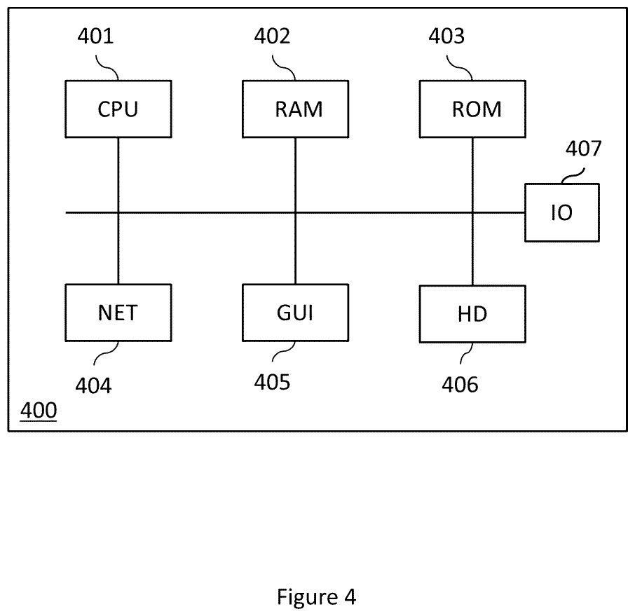

FIG. 4 is a schematic block diagram of an information processing device 400 for implementing one or more embodiments of the invention. The information processing device 400 may be a peripheral such as a microcomputer, a workstation or a mobile telecommunication terminal. The device 400 comprises a communication bus connected to:
a central processing unit 401, such as a microprocessor, denoted CPU;
a random access memory 402, denoted RAM, for storing the executable code of the method for implementing the invention, and the registers suitable for recording variables and parameters necessary for carrying out the method according to embodiments of the invention; the memory capacity of the device may be supplemented by an optional RAM memory connected to an expansion port, for example;
a read-only memory 403, denoted ROM, for storing computer programs for implementing the embodiments of the invention;
a network interface 404, denoted NET, which is normally connected to a communications network over which digital data to be processed are transmitted or received. The network interface 404 may be a single network interface, or be composed of a set of different network interfaces (for example wired and wireless interfaces, or various types of wired or wireless interfaces). Data packets are sent to the network interface for transmission or are read from the network interface for reception under the control of the software application executed in the processor 401;
a user interface 405, denoted GUI, for receiving inputs from a user or for displaying information to a user;
a storage device 406 such as described in the invention and denoted HD;
an input/output module 407, denoted IO, for receiving/sending data from/to external peripherals such as a hard disk, a removable storage medium or the like.

The executable code may be stored in a read-only memory 403, on the storage device 406 or on a removable digital medium such as, for example, a disk. According to one variant, the executable code of the programs can be received by means of a communications network, via the network interface 404, in order to be stored in one of the storage means of the communication device 400, such as the storage device 406, before being executed.

The central processing unit 401 is configured to control and direct execution of the instructions or of segments of software code of the program or programs according to one of the embodiments of the invention, which instructions are stored in one of the aforementioned storage means. After being turned on, the CPU 401 is capable of executing instructions from the main RAM memory 402 that relate to a software application. Such software, when executed by the processor 401, causes the methods described to be carried out.

In this embodiment, the device is a programmable device that uses software to implement the invention. However, in the alternative, the present invention can be implemented in the hardware (for example as an application-specific integrated circuit or ASIC).

Naturally, in order to meet specific needs, a person skilled in the field of the invention will be able to make changes to the above description.

Although the present invention has been described above with reference to specific embodiments, the present invention is not limited to these specific embodiments, and modifications that fall within the field of application of the present invention will be obvious to a person skilled in the art.

1. A method for transferring a current profile from a source secure element on a source device to a target secure element on a target device, the method comprising the following steps:
the source secure element monitoring and recording the changes made to an initial profile installed in the source secure element to obtain the current profile;
the source secure element generating a difference file relating to differences between the initial profile and the current profile on the basis of the recorded changes;
an SM-DP+ obtaining the initial profile and generating a profile to be installed on the target secure element; and
loading and installing the generated profile in the target secure element, the installed profile matching the initial profile to which the generated difference file has been applied.

2. The method as claimed in claim 1, characterized in that the method also comprises the following steps:
the source secure element transmitting the difference file to the SM-DP+; and
the SM-DP+ applying the difference file to the initial profile to generate the profile to be installed.

3. The method as claimed in claim 1, characterized in that the method also comprises the following steps:
the source secure element transmitting the difference file to the target secure element; and
if the generated profile matches the initial profile, the target secure element applying the difference file to the initial profile after it has been installed.

4. The method as claimed in claim 3, characterized in that the difference file is transmitted by the source secure element to the target secure element via the SM-DP+.

5. The method as claimed in claim 3, characterized in that the difference file is transmitted by the source secure element to the target secure element by way of a direct connection between the source device and the target device.

6. The method as claimed in claim 1, characterized in that if the current profile comprises Javacard applications, the difference file incorporates, for each Javacard application, a data packet that represents the state of the Javacard application.

7. A method for transferring a current profile from a source secure element on a source device to a target secure element on a target device, the method comprising the following steps by the source secure element:
the source secure element monitoring and recording the changes made to an initial profile installed in the source secure element to obtain the current profile;
the source secure element generating a difference file relating to differences between the initial profile and the current profile on the basis of the recorded changes; and
transmitting the difference file to the target device or to an SM-DP+ server.

8. A method for transferring a current profile from a source secure element on a source device to a target secure element on a target device, the method comprising the following steps by the target secure element:
loading and installing an initial profile;
receiving a difference file relating to differences between the initial profile and the current profile; and
applying the difference file to the installed initial profile to obtain the current profile.

9. A source secure element comprising a processor, the processor being configured to perform the following steps to transfer a current profile from a source secure element on a source device to a target secure element on a target device:
monitoring and recording the changes made to an initial profile installed in the source secure element to obtain the current profile;
the source secure element generating a difference file relating to differences between the initial profile and the current profile on the basis of the recorded changes; and
transmitting the difference file to the target device or to an SM-DP+ server.

10. A target secure element comprising a processor, the processor being configured to perform the following steps to transfer a current profile from a source secure element on a source device to the target secure element on a target device:
loading and installing an initial profile;
receiving a difference file relating to differences between the initial profile and the current profile; and
applying the difference file to the installed initial profile to obtain the current profile.
